(19) United States
(12) Patent Application Publication
(10) Pub. No.: US 2009/0210609 A1
(43) Pub. Date: Aug. 20, 2009

(54) Wireless USB hub

(76) Inventors: Iain Thomas Learmonth, N. Waltham (GB); Musa Ibrahim Kakish, Anaheim, CA (US)

Correspondence Address: LAMBERT & ASSOCIATES, P.L.L.C., 92 STATE STREET, BOSTON, MA, 02109-2004, US

(21) Appl. No.: 12/322,554

(22) Filed: Feb. 4, 2009

Related U.S. Application Data
(60) Provisional application No. 61/063,306, filed on Feb. 4, 2008.
(60) Provisional application No. 61/040,227, filed on Mar. 28, 2008.

(51) Int. Cl. G06F 13/00

(52) U.S. Cl. 710/316; 710/300

(57) ABSTRACT

A hub has a case with an up-stream Type A USB socket in a top surface and four down-stream Type A sockets in the side surfaces. The hub has internal circuitry interconnecting the ports. Unconventionally for a USB up-stream port, the power contacts of the Type A up-stream socket are provided with a voltage across them for powering the transceiver. However, this is switched off as follows to allow wired transfer of data from the computer, without voltage being passed back the computer.

### CROSS REFERENCE TO RELATED APPLICATION

This application claims the benefit of Provisional Application Ser. No. 61/063,306 filed on Feb. 4, 2008 and Provisional Application Ser. No. 61/040,227 filed on Mar. 28, 2008, the contents of which are hereby incorporated by reference.

### BACKGROUND OF THE INVENTION

1. Field of the Invention

The present invention relates to a wireless USB hub.

2. Description of the Related Art

Computers are connected to peripheral equipment, such as printers, by USB (Universal Serial Bus) ports and cables. Physical connection of a plurality of USB cables to a computer is tiresome, in particular where the computer is a laptop regularly moved and reconnected. This inconvenience is partially addressed by provision of a hub fanning out from a single cable from the computer to typically four cables to peripherals or indeed further hubs.

A wireless USB protocol has been written—known as Certified Wireless USB. Using this protocol, a computer can be equipped with a transceiver connected into a USB port and a hub can be equipped with its transceiver. This arrangement allows communication from the computer to the hub wirelessly.

Computers integrally equipped with a CWUSB transceiver are now known. These can communicate with a wireless USB hub without the need for a transceiver connected to a USB port of the computer. However there is the need to associate the hub transceiver with the computer transceiver, whereby they can exchange a unique protocol for permitting secure communication thereafter. For this direct—or at least wired—connection of the hub's transceiver with the computer is desirable, if not necessary.

### SUMMARY OF THE INVENTION

The object of the present invention is to provide wireless USB hub apparatus enabling ready association.

For the avoidance of doubt, in the following, the term “up-stream” is used in respect of a port in a hub for receiving input data from an up-stream, data source, such as a computer, and the term “down-stream” is used in respect of a port in a hub for outputting data to ultimate receivers of the data, such as computer peripherals. It should be noted that data does not always flow from the computer to the peripheral, as in the case of a printer for instance. Apart from hand shakes, data can flow primarily from peripheral to computer as in the case of a scanner.

According to the invention there is provided wireless USB hub apparatus comprising in combination:
a hub as such having:
   a plurality of USB down-stream ports and
   a USB up-stream port and
a wireless USB transceiver having a USB connector substantially complementary to the USB up-stream port,
   the transceiver being plugged into the up-stream port for receipt (or transmission) of data (known in the art as data communication) from (or to) a remote source for, via the hub, its transmission on to (or its receipt from ) a device or devices connected to one or more of the down-stream ports.

The transceiver preferably has a Type A USB plug, whereby it can be connected to a computer having a Type A socket for association with that computer, by exchange of encryption codes to enable one-for-one communication between the computer and the hub, whereafter the transceiver is reconnected to the up-stream port of the hub, which is a Type A socket, this being unconventional. For possible use of the hub in a wired manner, a Type A plug to Type A plug cable can be used.

The alternative is for the up-stream port to be a conventional Type B socket, with the transceiver having a type B plug, which is unconventional. For association, an adapter or cable having a Type A plug connected to a Type B socket can be provided. For wired use of the hub a conventional Type A plug to Type B plug cable can be used.

To power the transceiver from the hub, which will normally be provided with its own power supply, the USB up-stream port for the transceiver is provided with a power connection, which is unconventional. This power connection is preferably switched, whereby power cannot be passed back to a computer, if the up-stream port is used for wired connection to the computer.

The switching can be by a reed switch installed in the hub substantially adjacent the up-stream port, with a magnet being provided in the transceiver, to make the switch when the transceiver is plugged into the port.

Alternatively, the switch can be of the type made when physically engaged, with the transceiver being provided with a switch maker for making such engagement. Whilst the actuator could conceivably be substantially fixed on the transceiver, the provision of a fixed switch maker is liable to interfere with the ability to plug the transceiver into the computer. Accordingly the switch maker is preferably spring loaded towards its switch engaging position. In the preferred embodiment, the switch maker is provided with a latch for holding it and the transceiver in their engaged/plugged in positions.

According to another aspect of the invention, there is provided a transceiver for wireless computer communication of data to a data handling device, the transceiver having:
a USB plug and
means for activating a switch in the data handling device to switch power to the transceiver when the transceiver is connected to a USB port in the data handling device.

Whilst, as mentioned the means for activating the switch can be a magnet in the transceiver, preferably the transceiver has:
a body;
a latch slidingly mounted on body for latching the transceiver to the device; with the switch activating means mounted on the latch.

Again, the switch activating means can be a magnet mounted on the latch, but in the preferred embodiment, the switch activating means is:
a part of the latch arranged to act as a switch maker.

### BRIEF DESCRIPTION OF THE DRAWINGS

To help understanding of the invention, a specific embodiment thereof will now be described by way of example and with reference to the accompanying drawings, in which:

FIG. 1 is a perspective view of a USB hub of the invention;

FIG. 2 is a similar view of the hub of FIG. 1, with a transceiver of the invention fitted;

FIG. 3 is a side view of the transceiver shown in FIG. 2; and

FIG. 4 is a similar view of the transceiver engaged with the housing of the hub, which is shown partially and in cross-section.

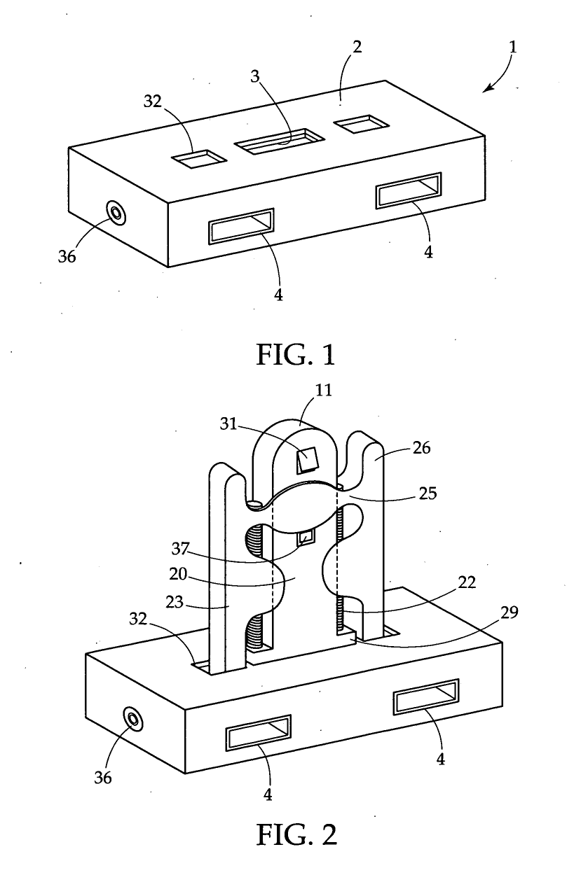

### DETAILED DESCRIPTION OF THE PREFERRED EMBODIMENT

Referring to the drawings, a hub 1 has case 2 with a Type A USB socket 3 in a top surface and four Type A sockets 4 in side surfaces. The socket 3 is an up-stream port and the sockets 4 are down-stream ports. The hub has internal circuitry interconnecting the ports, which circuitry is conventional—except for one detailed described below—and as such is within the capabilities of the skilled reader and will not be described in detail here.

A Certified Wireless USB transceiver 11 has a Type A USB plug 12. It can be connected to a computer (not shown), having a USB port and its own Certified Wireless USB transceiver, via its USB plug for initial association of the transceiver 11 with the transceiver of the computer, whereby they can communicate subsequently.

With the transceiver reconnected, the communication from the computer can be passed on to the down-stream ports 4, with one proviso. Unconventionally for a USB up-stream port, the power contacts of the Type A up-stream socket 3 are provided with a voltage across them for powering the transceiver. However, this is switched off as follows to allow wired transfer of data from the computer, without voltage being passed back the computer.

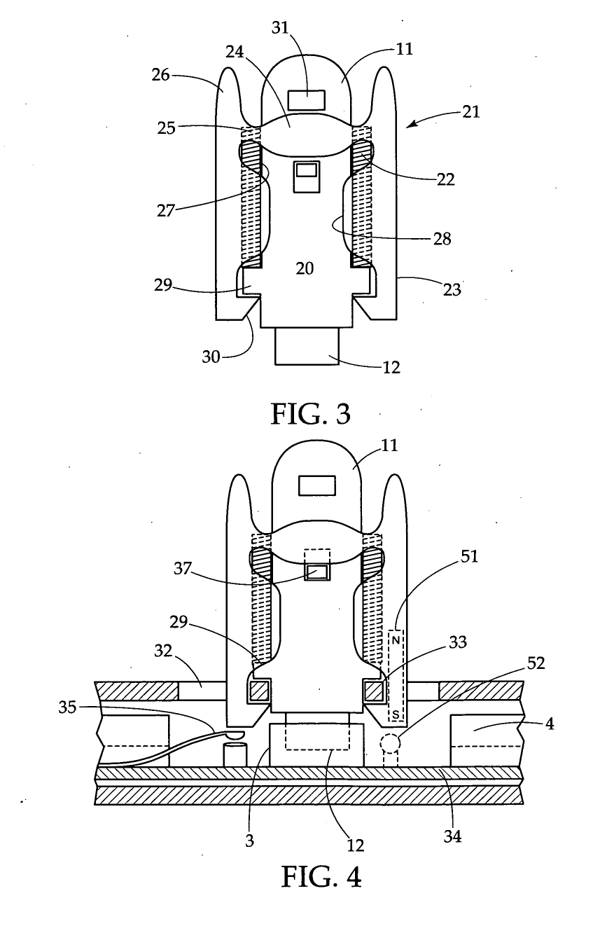

The transceiver carries a sliding clip 21, sprung by springs 22 away from the plug. The sliding clip has fingers 23 for engaging on the inside of the case at the up-stream port and a bridle 24 extending around the body 20 of the transceiver and interconnecting the fingers. The bridle is connected to the fingers by thin sections 25, whereby when upper extensions 26 of the fingers are squeezed together, the fingers are moved away from the edges 27 of the transceiver. Below the thin sections, the fingers have flanges 28, which extend to overlap the body of the transceiver. Thus they captivate the springs, which extend between the fingers and the edges of the transceiver. At one end, the springs abut the thin sections 25, and at the other lugs 29 extending from the edges 27. When the sliding clip is in its unclipped position as shown in FIG. 3, the distal ends of the fingers extend just below the lugs 29, with tapered clip features 30 engaging the underside of the lugs. Not only do the clip features hold the sliding clip on the transceiver body, but a wedge feature 31, over which the bridle is pushed on initial assembly, retains the sliding clip when pressure on the upper extensions lifts the clip features away from the lugs.

Since the sliding clip does not extend beyond the body of the transceiver, the latter can be connected to a computer's USB socket in the normal way by the transceiver's USB plug 12.

When the transceiver is first plugged into the hub, the plug 12 engages the up-stream port 3, with the sliding clip held up by the springs. The tapered clip features 30 enter apertures 32 on either side of the port 3 and are urged slightly apart by contact with the case portions 33 between the apertures and the port. Gripping of the upper extensions and pushing down springs the clip features past case portions until the features are inserted far enough to spring back under the portions 33, as shown in FIG. 4. The result is that the transceiver is securely held connected to the port 3.

The circuitry has a board 34, to which the up-stream port 3 is connected. Mounted on the board is a switch 35, for switching power to the up-stream port 3 from a power input 36 via a power control (not shown). The switch is made by contact with the distal end of one of the fingers, again as shown in FIG. 4. Thus when the transceiver is connected and the sliding clip engaged, the transceiver is powered.

The transceiver has a switch 37, which can be moved away from the plug setting the transceiver to association mode. The switch is automatically moved to its position for normal use by the bridle 24 on sliding of the sliding clip into its engaged position.

In case the transceiver is to be removed, the upper extensions 26 of the fingers 23 are squeezed together, releasing the clip features 30 and the transceiver.

The invention is not intended to be restricted to the details of the above described embodiment. For instance, as shown in FIG. 4, the transceiver or at least its sliding clip can be provided with a magnet 51 and the circuit board with a reed switch 52, whereby the power circuit to the transceiver is made by the magnet closing the reed switch when the transceiver is plugged into the hub.

The above described hub and transceiver combination has advantage in that the hub can be installed remote from the computer and does not need to be brought close to the computer for association, the transceiver being taken to the computer. Further, unless wired connection is required, the cost of a cable from the computer to the hub is avoided. Further if the computer is updated with a wireless transceiver of better performance, the hub transceiver alone needs to be replaced, not the entire hub.

What is claimed is:

1. A wireless USB hub apparatus comprising:
a hub comprising:
a plurality of USB down-stream ports; and
a USB up-stream port;
a wireless USB transceiver, wherein the USB transceiver includes a USB connector substantially complementary to the USB up-stream port,
the USB transceiver is plugged into the USB up-stream port and is disposed for data communication, through the hub, to a plurality of devices connected to one or more of the down-stream ports.

2. The wireless USB hub apparatus according to claim 1, wherein
the USB transceiver further comprises a Type A USB plug; and
the USB up-stream port further comprises a Type A USB socket.

3. The wireless USB hub apparatus according to claim 2, wherein a Type A USB plug to Type A USB plug cable is disposed to allow for wired connection of the hub.

4. The wireless USB hub apparatus according to claim 1, wherein
the USB transceiver further comprises a Type B USB plug; and
the USB up-stream port further comprises a Type B USB socket.

5. The wireless USB hub apparatus according to claim 4, wherein a Type A USB plug to Type B USB plug cable is disposed to allow for wired connection of the hub.

6. The wireless USB hub apparatus according to claim 1, wherein:
the hub further includes a power supply; and wherein
the USB up-stream port for the USB transceiver further comprises a power connection.

7. The wireless USB hub apparatus according to claim 6, wherein, the power connection is provided with a switch.

8. The wireless USB hub apparatus according to claim 7, wherein:
the switch is a reed switch located within the hub substantially adjacent the up-stream port; and
a magnet located within the transceiver, wherein the magnet is disposed to make the switch when the transceiver is plugged into the port.

9. The wireless USB hub apparatus according to claim 7, wherein:
the switch makes connections when physically engaged; and
the USB transceiver further comprises a switch actuator, wherein the switch actuator is disposed for making the engagement.

10. The wireless USB hub apparatus according to claim 9, wherein the switch actuator is substantially fixed on the transceiver.

11. The wireless USB hub apparatus according to claim 9, wherein the switch actuator is substantially attached in a spring loaded manner on the transceiver.

12. The wireless USB hub apparatus according to claim 9, wherein the switch actuator further comprises a latch, wherein the latch is disposed for holding the switch actuator and the USB transceiver in their engaged positions.

13. A transceiver for wireless computer communication of data to a data handling device, the transceiver comprising:
a USB plug; and
means for activating a switch in the data handling device to switch power to the transceiver when the transceiver is connected to a USB port in the data handling device.

14. The transceiver according to claim 13, wherein the means for activating the switch is a magnet in the transceiver.

15. The transceiver according to claim 13, wherein the transceiver further comprises:
a body; and
a latch slidingly mounted on the body, wherein the latch is disposed for latching the transceiver to the device.

16. The transceiver according to claim 15, wherein the switch activating means is mounted on the latch.

17. The transceiver according to claim 16, wherein the switch activating means is a magnet mounted on the latch.

18. The transceiver according to claim 15, wherein the switch activating means is integral with the latch, wherein the switch activating means is disposed to function as a switch actuator.

19. The transceiver according to claim 15, wherein the transceiver further includes a switch, comprising an ability to be manually set to a state for association of the transceiver and disposed to be returned to an operating state by the latch when latching the transceiver to the data handling device.
